(19) United States
(12) Patent Application Publication
(10) Pub. No.: US 2007/0089469 A1
(43) Pub. Date: Apr. 26, 2007

(54) Liquid leaf fertilizer composition

(75) Inventor: Matti Hantula, Pentinmäki (FI)

Correspondence Address: VENABLE LLP, P.O. BOX 34385, WASHINGTON, DC, 20043-9998, US

(73) Assignee: Timo Hantula and Markku Hantula, Pentinmäki (FI)

(21) Appl. No.: 10/560,242

(22) PCT Filed: Jun. 10, 2004
(86) PCT No.: PCT/FI04/50087

§ 371 Date: Dec. 12, 2005

(30) Foreign Application Priority Data
Jun. 10, 2003 (FI) 20030869

(51) Int. Cl. C05D 9/02

(52) U.S. Cl. 71/11

(57) ABSTRACT

A liquid sprayable leaf fertilizer composition which contains a growth-promoting, long-chained, substantially water-insoluble carbon compound, such as an aliphatic alcohol, in a liquid carrier substance. The composition includes the long-chained carbon compound, particularly an aliphatic alcohol, dissolved in oil, the composition being an oil-in-water emulsion. The invention also relates to the use of the composition for supplying a growth-promoting substance onto the superterranean parts of plants. The aliphatic alcohol is preferably 1-triacontanol, and the oil is a vegetable oil, such as rapeseed oil.

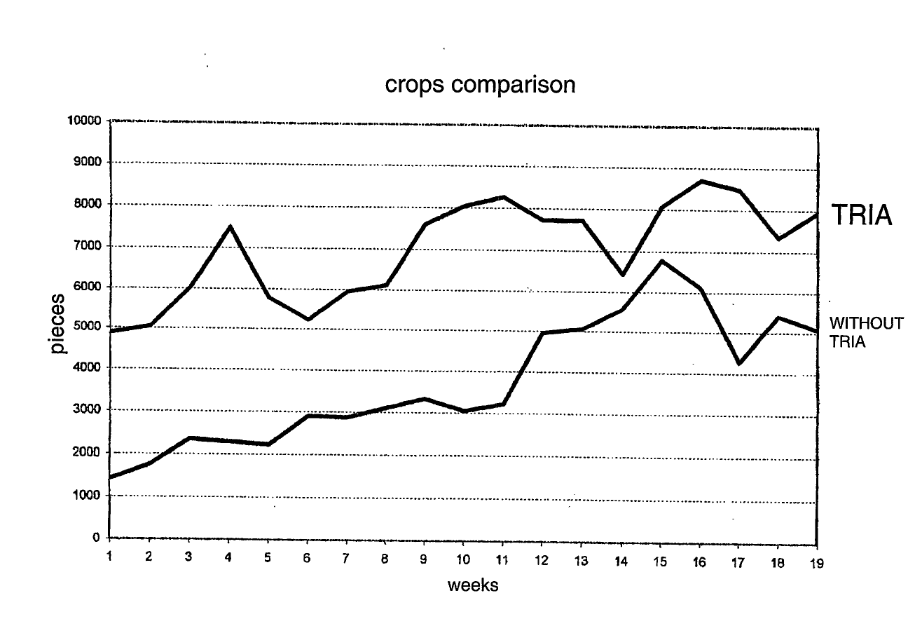

The invention relates to a liquid leaf fertilizer composition which contains a growth-promoting, long-chained, substantially water-insoluble carbon compound, such as an aliphatic alcohol, in a liquid carrier substance.

In addition to nutrient substances to be supplied via roots, so-called foliar fertilizers are known which are supplied to the superterranean parts of plants, for example by spraying with an aqueous medium. Such substances have been found to have a favourable effect on the plants' mechanisms of photosynthesis. The aim of the present invention is not to present a new effective agent nor a novel mechanism of action but to present a composition, by which it is possible to improve the usability and/or effect of effective agents which are previously known or which may be found later.

The aim of the invention is particularly to improve the usability and/or effect of long-chained carbon compounds when they are spread by spraying or in another way in a so-called aqueous foliar fertilizer onto the overground parts (leaves) of plants.

One example of the above-mentioned long-chained organic carbon compounds is the 30-carbon aliphatic alcohol 1-triacontanol, CH₃(CH₂)₂₈CH₂OH. The effect of triacontanol and various compositions containing it are presented e.g. in U.S. Pat. Nos. 4,150,970, 4,333,758, 4,452,632, and 4,420,329, as well as in European patent EP 352 885.

A common problem in such long-chained organic substances is their poor solubility or insolubility in water. Because the quantities of spreading, for example per hectare under cultivation, are small (normally less than 1 g/ha), a particular problem is how to distribute this effective agent evenly in the small concentration. In the following, the properties of these substances will be described with reference to triacontanol as the very example.

In the nature, triacontanol occurs in the surface wax of many plants. Well-known sources of triacontanol include alfalfa and sugarcane. Triacontanol is also found in beeswax.

The growth promoting effect of triacontanol has been known as long as from the 1970's (Ries et al., U.S. Pat. No. 4,150,970, and Science, vol. 195 (1977), pp. 1339-1341). The substance can also be made synthetically (e.g. U.S. Pat. No. 4,452,632). Triacontanol is characterized in being effective in very small concentrations as hormones are. The mechanism of action is primarily to increase the rate of photosynthesis and thereby to improve the productive capacity of the plants. Triacontanol activates the plant's genes controlling the photosynthesis, which genes, in turn, act on the enzymes controlling the dark reactions of photosynthesis (Rubisco enzymes), Xingping Chen et al., Plant Cell Physiol. 43 (8) 869-876 (2002). Similar effects have also been shown with short-chained aliphatic alcohols: methanol, ethanol, isopropanol, N-butanol (WO-94/00009).

Because very small quantities of 1-triacontanol are needed but, on the other hand, very large quantities of water must be used to treat the growths evenly and to spread the triacontanol uniformly, it is of primary importance to distribute the triacontanol or corresponding effective agent as evenly as possible in the carrier, with which the effective agent is sprayed onto the growth.

Triacontanol is practically insoluble in water, but it can be dissolved in many organic solvents (acetone, ethanol, etc.) which can be further dissolved in water to form spray solutions or tank mixtures. The best known solvent is chloroform. As an auxiliary agent in such compositions, it is possible to use an agent to reduce the surface tension, such as Tween-20.

Another useful method is to prepare, by ultrasound dissolution of triacontanol, a colloid in water and the agent reducing the surface tension, in which colloid the particles are so small that the colloid is relatively stable. Such a method is presented e.g. in EP patent 352 885, which discloses triacontanol particles which are ultrafine, smaller than 0.3 μm.

When triacontanol, dissolved in easily evaporable solvents, or an aqueous colloid is spread onto plants, the leaves of the plants dry relatively fast and the effective agent is crystallized onto the surfaces of the leaves, without achieving an intracellular effect. Furthermore, in the colloid, the particles are always of different sizes and unnecessarily large.

Now, it has been found that by using a novel carrier substance, it is possible to distribute triacontanol and other long-chained carbon compounds in dissolved form evenly in the carrier, and the efficiency of the product can be significantly improved without damaging the plants. Consequently, the effective agent can be spread very evenly onto the leaves in a form suitable for the plants.

Triacontanol is dissolved in oils which can be characterized as fats in fluid form. Natural fats (triglycerides of fatty acids) are advantageous auxiliary agents because of their safety and biodegradability. Therefore, triacontanol or a corresponding long-chained effective agent can be dissolved, for example, in rapeseed oil, rubseed oil, olive oil, sunflower oil, or other vegetable oils. Emulgators can be added into the oil to make a smooth aqueous emulsion (oil-in-water emulsion) in a tank mixture, and a spray that is easily distributed on the leaves of plants. The spray solution is slowly evaporable and leaves the plant leaves with a thin fat layer containing triacontanol dissolved in it. The long-chained effective agent can penetrate the cells of the leaves better from the oil. This can be thought to be due also to the fact that the oil dissolves the wax in the cuticula of the leaves. Since triacontanol increases the rate of photosynthesis to a substantial extent, the carbon demand of the plants is also increased, and the lack of intracellular carbon may become a factor to limit the growth. This can be ameliorated by adding short-chained alcohols, in quantities tolerated by the plants, into the tank mixture (alcohols are described in WO 94/00009; Benson & Nonomura). In the oil-in-water emulsion of the tank mixture, these alcohols enter the aqueous phase.

Because vegetable oils are natural products and are biodegradable, they are very suitable for compositions to be sprayed onto plants. In addition to triglycerides, the oil contains many natural small components which originate from the raw material plant and do not have a harmful effect on the plant.

The direct dissolution of triacontanol in oils is technically unnecessarily demanding, so it is sensible to use, as a preliminary solvent, for example chloroform or another fat-soluble organic solvent in a quantity which is small in relation to the oil volume.

In the following, we shall present one feasible procedure:
1. Dissolve 100 mg of 1-triacontanol in 100 ml of chloroform.
2. Prepare 10 litres of a rapeseed oil based fixing agent containing 10 wt-% of non-toxic emulgators of the foodstuff category.
3. Dissolve 2 ml of a solution of triacontanol in chloroform in 10 litres of the above-mentioned fixing agent to give a fixing agent containing triacontanol, wherein the triacontanol content will be 2 mg per 10 l of rapeseed fixing agent.
4. In a plant protection mixing spray, prepare a tank mixture containing
   0.5 wt-% of the triacontanol-containing fixing agent,
   20 wt-% of Carbon Kick leave fertilizer (60 wt-% ethanol solution in water+plant nutrients+glycine),
   79.5 wt-% of water.
5. With this tank mixture, the growths can be sprayed by using, in field cultivation, 100 litres per hectare or, respectively, in a greenhouse, 100 litres per 1000 m² for a full-height growth.

What is essential is that the triacontanol is completely dissolved and penetrates well into the leaves of the plant, the solute is not evaporated from the leaves, and small quantities of triacontanol can be used. From the above example, we can calculate that the 1-triacontanol concentration in the tank mixture ready to be sprayed is 1 ppb (1 part per billion), and that for cultivation in the field and in a greenhouse, 0.1 mg per hectare and 1 mg/ha will be sufficient for a full-height growth, respectively. The scale can be changed, if necessary, but it is essential to dose the triacontanol in a form dissolved in oil, wherein the oil-in-water emulsion forms the actual composition to be sprayed onto the growth.

When using a fixing agent concentration as high as 0.5 wt-%, so much oil can be supplied onto the leaves of the plant that it suppresses the erysiphales (powdery mildew), the mites, and the thrips. With a weekly treatment in the greenhouse, cultivation without any pesticides is possible.

It is obvious that the concentrations of 1-triacontanol in the tank mixture ready to be sprayed may vary. Depending on the plant to be treated and the area to be cultivated, the concentration is generally from 20 ppm to 0.5 ppb. The fixing agent (the oil which contains triacontanol) may be present in various strengths, i.e. in various concentrations of the effective agent, wherein it is always possible to make an aqueous solution with an oil concentration of about 0.5 wt-% and a desired concentration of triacontanol. It is also possible to use aqueous emulsions, in which the oil concentration is different from that mentioned above, for example from 0.3 to 2.0 wt-%.

The invention is not limited to 1-triacontanol only, but it can also be applied in other substantially water-insoluble but oil-soluble long-chained organic carbon compounds having a favourable (photo-synthesis enhancing) effect on the growth of plants when supplied onto the leaves, particularly alcohols containing 20 or more carbon atoms in the chain, preferably aliphatic alcohols, or their derivatives, such as esters. In particular, the invention is suitable for aliphatic alcohols, or their derivatives, such as esters, which are close to triacontanol and contain 28 to 32 carbon atoms.

The following example illustrates the effect of the treatment on radish (TRIA=1-triacontanol).
Plant material: Radish, sowed on 4 Feb. 2003, 10 cm pot, one seedling per pot, substrate: fertilized peat
Growing conditions: 18° C., 24 h exposure to light, about 150 μmol/(m²×s) PPFD (photosynthetic photon flux density).
Treatment: Control 1 (water)

Control 2 (0.5% rapeseed oil)

| | | |
|---|---|---|
| TRIA | 0.1 | ppm |
| TRIA | 1.0 | ppm |
| TRIA | 10.0 | ppm |

TRIA was dissolved in a small quantity of ethanol and mixed with rapeseed oil (5 mg of TRIA, 50 ml of oil) in an ultrasound sudatory, about 60° C., 30 min, and was dissolved with rapeseed oil into use concentrations, after which an aqueous emulsion was prepared which contained 0.5% of rapeseed oil. The plants were treated with the emulsion so that the leaves became wet.
Measurements: After the treatment, the seedlings were grown under said growing conditions from 13 to 26 March. Of the seedlings, the leaves were counted and the fresh and dry weights of the overground parts were measured. Each treatment was made for nine plants.

Results:

| | No. of | Fresh weight | Dry weight |
|---|---|---|---|
| Treatment | blades | mg/plant | mg/plant |
| Control 1 | 4.1 | 3.03 (100) | 0.23 (100) |
| Control 2 | 4.0 | 3.15 (104) | 0.25 (109) |
| TRIA 0.1 | 4.4 | 3.35 (110) | 0.26 (113) |
| TRIA 1.0 | 4.4 | 4.10 (135) | 0.33 (143) |
| TRIA 10.0 | 4.6 | 3.89 (128) | 0.30 (130) |

The second example illustrates the treatment for cucumber:
The test was run from 4 Apr. to 1 May 2003 in a greenhouse. The normal production takes place in greenhouses with lighting equipment, the lighting power being about 200 W/m². The cultivation takes place in a peat substrate which is placed in benches in such a way that every time when the growth is changed, the substrate is also changed. The aim has been to optimize the growing conditions for light, temperature, humidity of air, watering, fertilization, and carbon dioxide (800 ppm). As a particular feature, the cultivation measures also include the dosage of a carbon fertilizer (ethanol) via a spraying apparatus (Priva) onto the leaves of the growth once a week. With these measures, the market garden achieves an average annual production of 120 kg/brm² which is the highest in Finland.
The above-described conditions were kept unchanged, but one representative row of seedlings in the greenhouse was treated according to the Carbon Kick® Growing Systems in the following way:
Triacontanol dissolved in chloroform was dissolved into the Carbon Kick fixing agent (rapeseed oil), 2 mg/10 l. The tank mixture also contained 0.15 l of the fixing agent, 2.0 l of a carbon fertilizer (60% ethanol) and 8.0 l of water.
Consequently, in addition to water and rapeseed oil, the tank mixture contained 3 ppb of triacontanol and 12% of ethanol. In normal cultivation (control), the carbon fertilizer was applied, without the oil-based fixing agent and triacontanol.
The treatments were started when the first pistillate flowers blossomed out. In the treatment, the plants were sprayed wet with a backpack pressure sprayer. The treatments were repeated on 4 April, 11 April, 19 April, 26 April, and 1 May.

During harvesting, the cucumbers of the treated row of seedlings were weighed separately every day, and those of the adjacent reference row were weighed in a similar way.

Yield results

| Date of harvest | Treated kg | Control kg |
|---|---|---|
| 18 April. | 7.0 | 2.2 |
| 19 April | 14.1 | 13.1 |
| 21 April | 37.8 | 36.7 |
| 22 April | 20.4 | 10.9 |
| 24 April | 37.4 | 49.5 |
| 25 April | 36.5 | 23.3 |
| 26 April | 29.1 | 29.2 |
| 28 April | 23.4 | 26.3 |
| 29 April | 19.9 | 18.1 |
| 30 April | 23.3 | 22.8 |
| 1 May | 13.5 | 11.9 |
| | 262.4 kg | 244.0 kg |

Observations:
1. The treated plants matured to harvest one day earlier.
2. The crop yield was raised by 7.5% during the first 11 harvest times.
3. The treated growth had a darker green and fresher appearance up to the top.

Finally, we present a cultivation test on cut roses:
The test was run in greenhouses during the winter and spring of 2002 to 2003.
For cut rose production, the market garden has two greenhouses with a joint gross area of 1350 m². In these, cut roses are cultivated in benches with a width of 120 cm so that the net production area is about 800 m². The cultivation takes place in the conventional way (no bending cultivation), and cutting down is performed once a year in the summer. The greenhouses are plastic greenhouses with double roofing, the growing substrate is rock wool, the lighting installation power is about 190 W/m², and carbon dioxide is supplied into the air (800 ppm) always when the ventilation panels are closed. During the dark season, lighting is provided 20 hours a day. The varieties of roses are diversified. The majority, however, are varieties with large blossoms (Kardinal, Amadeus, Corrie).
At the end of the year 2002, various tests on the growth were started with triacontanol, and by the turn of the year, treatments were performed regularly with the above-described tank mixture containing 20% of carbon fertilizer (ethanol) and 0.5% of Carbon Kick fixing agent (rapeseed oil+emulgator) which also contains 1 ppb of triacontanol.
The effects have been dramatic. In only four hours after the treatment, the leaves of the plants have become clearly darker and thicker and firmer. In a longer term, there has been an increase in the growth rate, the number of sprouts has increased and the size of blossoms and the thickness of the stem has substantially increased.
The attached chart illustrates the crop of flowers collected every week from the same area and treated with the above-mentioned tank mixture with and without triacontanol.
The chart gives an idea of the number of the flowers but not of their quality. However, one should point out that the quality has changed even more dramatically than the number. However, there are no figures documented of the quality.

1-10. (canceled)

11. A liquid sprayable leaf fertilizer composition, comprising:
a growth-promoting, long-chained, substantially water-insoluble carbon compound dissolved in oil.

12. The composition according to claim 11, wherein said long-chained carbon compound is dissolved in oil through an organic solvent.

13. The composition according to claim 11, wherein the composition is an oil-in-water emulsion comprising an aqueous phase.

14. The composition according to claim 13, wherein the aqueous phase comprises a short-chained (1 to 4 carbon atoms) aliphatic alcohol dissolved in it.

15. The composition according to claim 14, wherein the short-chained aliphatic alcohol is ethanol.

16. The composition according to claim 11, wherein the carbon compound is a long-chained aliphatic alcohol containing 28 to 32 carbon atoms, or its derivative.

17. The composition according to claim 16, wherein the carbon compound is 1-triacontanol or its derivative.

18. The composition according to claim 13, wherein the carbon compound is a long-chained aliphatic alcohol containing 28 to 32 carbon atoms, or its derivative.

19. The composition according to claim 18, wherein the carbon compound is 1-triacontanol or its derivative.

20. The composition according to claim 14, wherein the carbon compound is a long-chained aliphatic alcohol containing 28 to 32 carbon atoms, or its derivative.

21. The composition according to claim 20, wherein the carbon compound is 1-triacontanol or its derivative.

22. A composition for preparing a liquid aqueous sprayable leaf fertilizer composition, a so-called tan mixture, the composition comprising:
a growth-promoting, long-chained, substantially water-insoluble carbon compound; and
an oil in which said long-chained carbon compound is dissolved.

23. The composition according to claim 22, further comprising:
an emulgator.

24. The composition according to claim 22, wherein said long-chained carbon compound is dissolved in the oil through an organic solvent.

25. The composition according to claim 22, wherein said long-chained carbon compound is a long-chained aliphatic alcohol containing 28 to 32 carbon atoms, or its derivative.

26. The composition according to claim 25, wherein the carbon compound is 1-triacontanol or a derivative thereof.

27. The composition according to claim 23, wherein said long-chained carbon compound is a long-chained aliphatic alcohol containing 28 to 32 carbon atoms, or its derivative.

28. The composition according to claim 27, wherein the carbon compound is 1-triacontanol or a derivative thereof.

29. The composition according to claim 24, wherein said long-chained carbon compound is a long-chained aliphatic alcohol containing 28 to 32 carbon atoms, or its derivative.

30. The composition according to claim 29, wherein the carbon compound is 1-triacontanol or a derivative thereof.

31. The use of a composition according to claim 11 for supplying a substance that promotes growth by enhancing photosynthesis, onto the superterranean parts of plants.

32. The use of a composition according to claim 18 for supplying a substance that promotes growth by enhancing photosynthesis, onto the superterranean parts of plants.

33. The use of a composition according to claim 22 for preparing a composition to be supplied onto the superterranean parts of plants, by mixing into water.

34. The use of a composition according to claim 27 for preparing a composition to be supplied onto the superterranean parts of plants, by mixing into water.
